(19) United States
(12) Patent Application Publication
(10) Pub. No.: US 2006/0213672 A1
(43) Pub. Date: Sep. 28, 2006

(54) Weather adjustment system for fighting fires

(76) Inventor: John Anthony Mohr, Camarillo, CA (US)

Correspondence Address: NAVAIRWD COUNSEL GROUP, 575 "I" AVE, SUITE 1 (CODE K00000E), BUILDING 36, ROOM 2308, POINT MUGU, CA, 93042-5049, US

(21) Appl. No.: 11/094,547

(22) Filed: Mar. 22, 2005

(51) Int. Cl. A62C 27/00; A62C 2/00

(52) U.S. Cl. 169/24; 169/46

(57) ABSTRACT

A weather adjustment system for fighting forest and brush fires under dry, hot and winding conditions which includes a fan/blower for generating wind at extremely high speeds, a water source which supplies cold water into the wind forming a stream of cold water particles and a screen mesh which provides very fine particles of water within the stream. The stream is directed to a forest or brush fire dropping the temperature at the edge of the fire which eventually extinguishes the fire.

### BACKGROUND OF THE INVENTION

1. Field of the Invention

The present invention relates generally to fire fighting equipment. More specifically, the present invention relates to a fan type blower weather adjustment system which is useful in fighting fire and may be an integral component of a fire fighting vehicle's fire fighting system.

2. Description of the Prior Art

Forest and grass land fires in the western states including California are a constant concern because of the lack of moisture, the extremely short raining season, the high winds and the long hot summers. Starting in mid summer and continuing through the fall the chance of serious fires is high since spring growth caused by winter rain is dry and there is virtually no precipitation during the summer months. During the summer and fall, when a scrub brush or forest fire starts it will generally spread rapidly and is extremely difficult or impossible to control. The result can be a lose of forest and houses and buildings surrounding the area where the fire is burning. During a typical fire season in Southern California damages to property can cost be as high as a billion dollars or more.

When the rain finally arrives in December and January the ground is often barren of vegetation which results in erosion of the soil and mud slides. This leads to additional property lose since homes and commercial building are on unstable soil especially on hillsides and in canyons. There may also be homes severely damaged when cliffs erode sending thousand of cubic feet of mud into occupied homes.

Conventional methods for fighting fires under dry and windy conditions include the use fire fighting vehicles for directing high pressure water or fire retardants at the fire. Aircraft with water scoops have been used to fight forest and brush fires under dry and windy conditions. Fire breaks are another technique used by fire fighters to fight forest and brush fires under dry and windy conditions.

Water is directed at the fire from a nozzle which results in the fire being controlled by fire fighters in only one extremely small area. A fast moving fire will often jump a fire break. Fire retardants are not safe to use in residential areas because they contain environmentally unsafe chemicals which are harmful to animals and humans. Aircraft with water scoops are very limited in the capabilities in that they can fly in high winds and take a significant amount of time to fill their scoops and return to the fire.

Accordingly, there is a need for a fire fighting apparatus which is effective and efficient at fighting forest and brush fires under dry and winding conditions.

### SUMMARY OF THE INVENTION

The present invention overcomes some of the difficulties of the past including those mentioned above in that it comprises a relatively simple yet highly effective fire fighting blower for use in fighting forest and brush fires under hot, dry and windy conditions.

The weather adjustment system of the present invention includes a fan or blower for moving air from the atmosphere through the fan housing exiting the housing at extremely high speeds/velocities, e.g. between 30 and 200 mph. Cold water is then pumped into the resultant air flow generating particles of water. An optional filter/screen mesh may then be used to generate very fine particles of water in the order of several microns, e.g. 10-200 microns.

The particle size cold water droplets are driven into the atmosphere at the fire's edge dropping the temperature considerably at the edge of the fire which creates barrier against the fire. This, in turn, prevents the fire from spreading and the resulting heat loss will eventually extinguish or put out the fire.

The fan or blower is generally mounted on a fire fighting vehicle or on a mobile platform which is towed to the fire. When the fire is in a residential or commercial area fire hydrants supply the water used to fight the fire.

### BRIEF DESCRIPTION OF THE DRAWINGS

FIG. 1 is a block diagram which depicts the weather adjustment system used to fight forest and brush fires under dry and windy conditions;

FIG. 2 illustrates the weather adjustment system of FIG. 1 which has the fan/blower mounted on a fire fighting vehicle;

FIG. 3 illustrates the weather adjustment system of FIG. 1 which has the fan/blower mounted on a trailer which is towed by the fire fighting vehicle;

FIG. 4 illustrates the weather adjustment system of FIG. 1 which has the fan/blower mounted on a fire fighting vehicle boom; and

FIG. 5 illustrates an electrical circuit for supply power to a plurality of fire fighting vehicle fans.

### DETAILED DESCRIPTION OF THE PREFERRED EMBODIMENTS

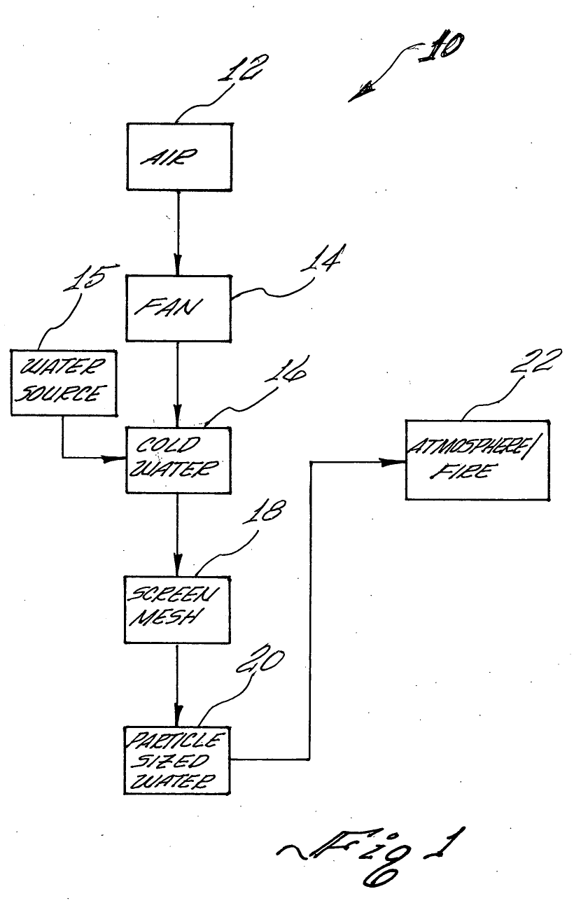

Referring to FIG. 1, there is shown a block diagram of a weather adjustment system 10 which is used to fight forest and brush fires under hot, winding and dry conditions. A blower/fan 14 moves air 12 from the atmosphere through the fan housing exiting the housing at extremely high speeds, e.g. between 30 and 200 mph. Cold water 16 is then pumped into the resultant air flow generating particles of water. The temperature range of the water is generally in the range of 40 to 70 degrees Fahrenheit. An optional filter/screen mesh 16 may be used to generate very fine particles of water in the order of several microns, e.g. 10-200 microns.

Particle size cold water droplets 20 are driven into the atmosphere 22 which drops the temperature considerably at the edge of the fire creating a barrier against the fire. This, in turn, prevents the fire from spreading and the resulting heat loss will extinguish or put out the fire.

The fan 14 may be any conventional centrifugal machine which draws air into its casing using a rotating impeller or fan blade assembly. The fan blade assembly is driven by an electric motor which may be either an AC machine or a DC machine. Air flowing through the casing is accelerated exiting the casing at high speeds and medium to high pressures. A wind tunnel type fan or blower is typical of the fan used in the preferred embodiments of the invention.

The water source 15 for supplying cold water can be any of a number of sources such a fire hydrant in an industrial or commercial area. Other sources of cold water include a pump which is used to pump cold water from a lake or a reservoir, a separate vehicle having a water tank and a fire fighting vehicle which carries a water tank.

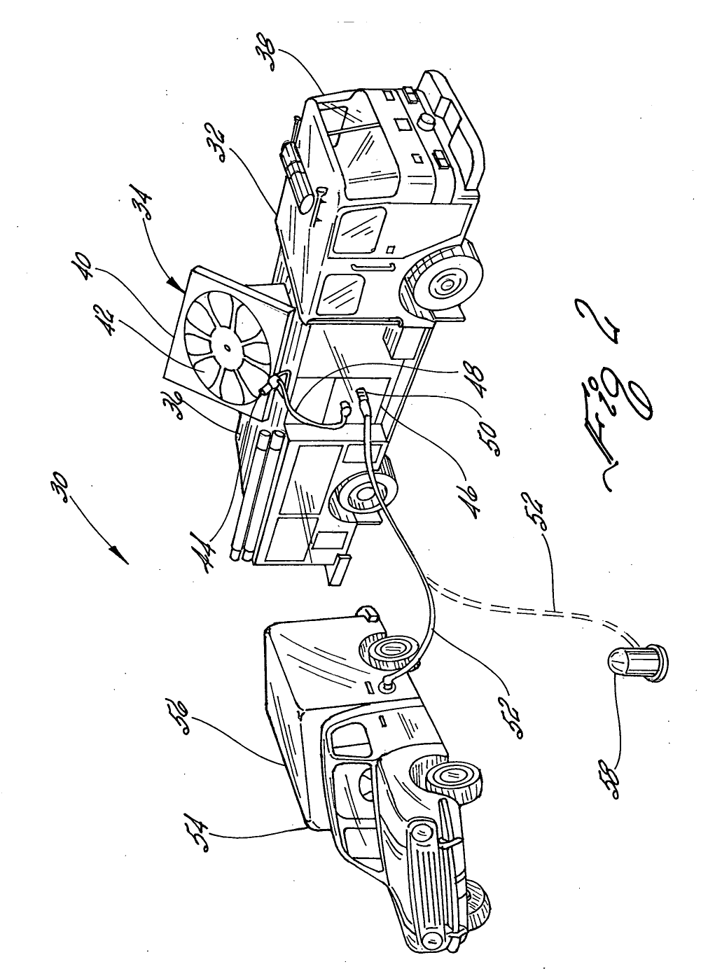

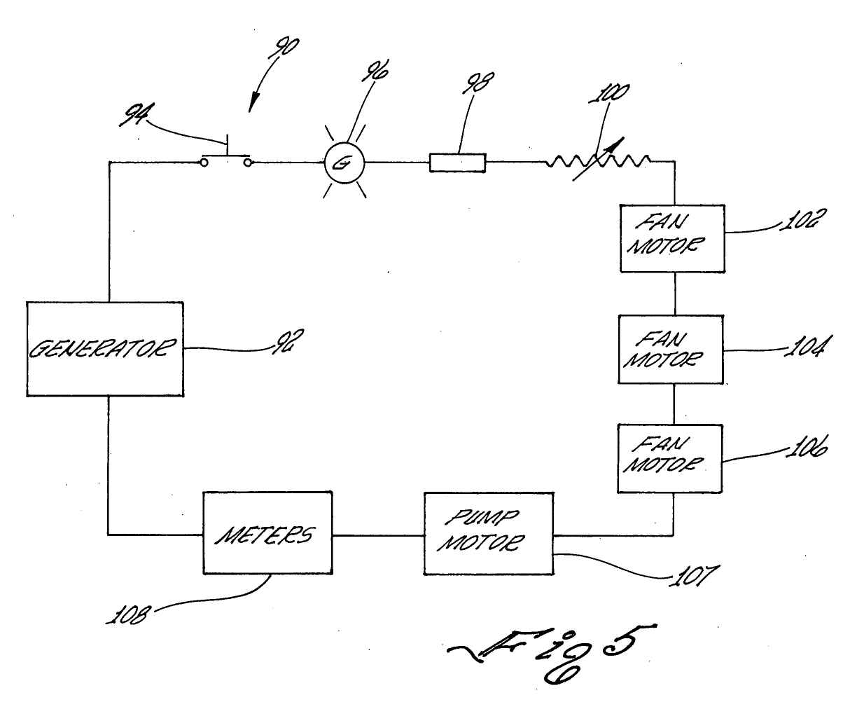

Referring to FIGS. 2, 3 and 4, there are shown preferred embodiments of the present invention. FIG. 2 illustrates the weather adjustment system 30 for fighting fires which comprises a fire fighting vehicle 32 and a fan/blower 34 mounted on the upper rear portion 36 of the fire fighting vehicle 32 behind the cab 38 of vehicle 32. Fan/blower 34 includes a fan housing 40 and a fan blade assembly 42 comprising a plurality of individual fan blades. An electric fan motor 102, 104 or 106 (FIG. 5) is energized to rotate fan blades 42.

Mounted in front of the fan blade assembly 42 on fire fighting vehicle 32 is a nozzle 44. Nozzle 44 is connected to the water storage tank 46 on fire fighting vehicle 32 by a hose 48. Since the water storage tank 46 on fire fighting vehicle 32 generally has limited storage capacity a water inlet valve 50 is provided for the storage tank 46. A hose 52 which has one end connected to the water storage tank 46 on vehicle 32 and the opposite end connected to a vehicle 54 which includes a water storage tank 56. Water storage tank 56 generally holds several thousand gallons of water to re-supply the water storage tank 46 on fire fighting vehicle 32.

At this time it should be noted that each fan blade assembly 42 for fan motors 102, 104 and 106 has a nozzle 44 positioned in front of the fan blade assembly 42 when multiple blowers and their associated nozzles are being utilized to generate streams of cold water particles to fight forest and brush fires.

An alternate source of water is a fire hydrant 58 when the fire is near an industrial, commercial or residential area. The fire hydrant 58 is connected the inlet valve 50 for storage tank 46 by hose 52 which is now shown in phantom.

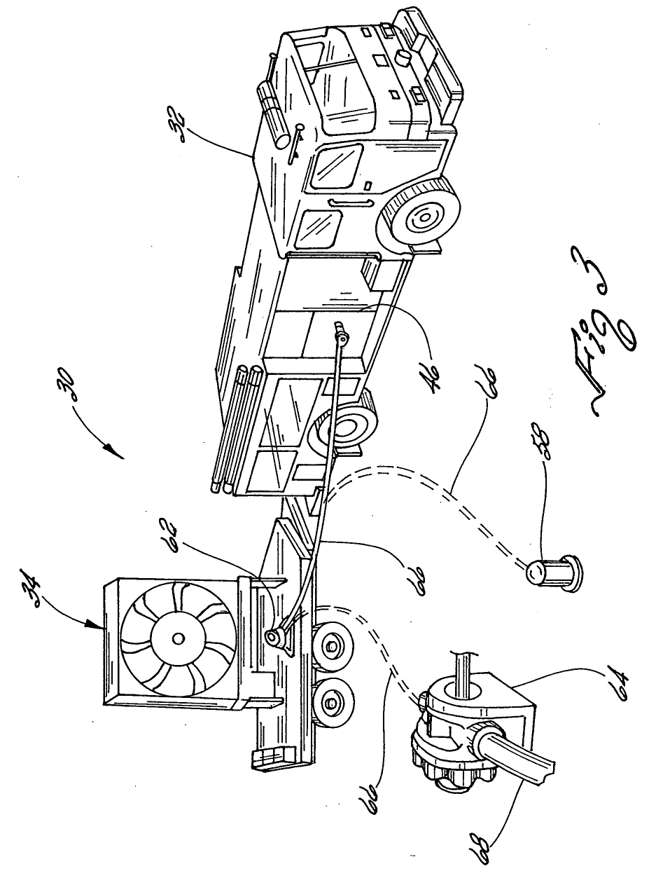

FIG. 3 illustrates the fan/blower 34 being towed being towed by the fire fighting vehicle 32 to the fire. The fan/blower 34 is mounted on a mobile platform 60 along with a nozzle 62 which is positioned in front the fan/blower 34. Water for the nozzle is supplied by storage tank 46 on vehicle 32, fire hydrant 58 or a pump 64. A hose 66 is used to connect storage tank 46, fire hydrant 58 or the discharge port of pump 64 to nozzle 62. A hose 68 connected to the inlet port of pump 64 is used by pump 64 to draw water from a source such as a lake, stream or reservoir.

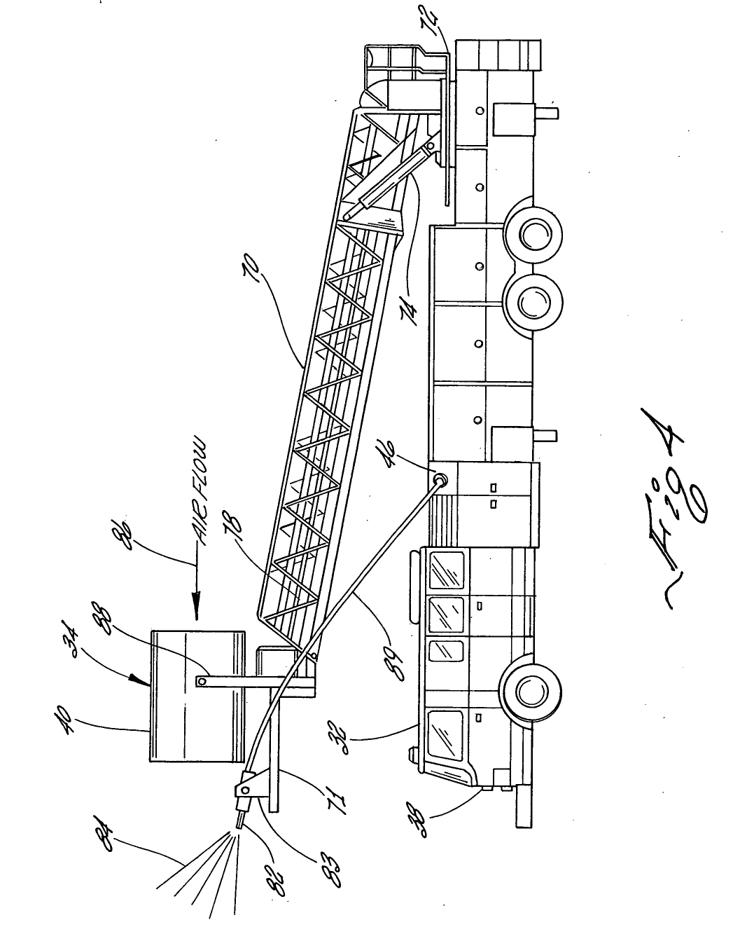

FIG. 4 illustrates the fan/blower 34 mounted on a platform 71 at the upper/head end of a boom 70. The lower/tail end of boom 70 is connected to a platform 72 which rotates three hundred sixty degrees allowing the user of fire fighting vehicle 32 to rotate boom 70 and fan 34 to any desired positioned. A pair of hydraulic jacks 74 attached to platform 72 and boom 70 raise and lower boom 70, platform 71 and fan/blower 34. The boom 70 also has a ladder 78 which extends outward from the lower portion of the boom 70 and retracts into the lower portion of the boom 70. A nozzle 82 mounted on platform 71 in front of fan/blower 34 directs a stream of cold water 84 at the fire. Strong winds generated by fan/blower 34 cause water particles to form within the stream of cold water 84 which when directed at a fire provide a barrier against the fire. The resultant temperature drop from the particles in the stream of cold water 84 will eventually extinguish the fire.

The fan housing 40 is rotatably mounted on a U-shaped support bracket 88 which allows for rotation of the fan housing 40 from a horizontal position as shown in FIG. 4 approximately ninety degrees to a vertical position. In a like manner nozzle 82 is rotatably mounted on nozzle support bracket 83 attached to platform 71. Thus, a user can change the direction of flow of the stream of cold water 84 by simultaneously rotating nozzle 82 and fan housing 40. The rotation of housing 40 and nozzle 82 is either by a manual adjustment from platform 71 or from controls located in the cab 38 of fire fighting vehicle 32.

A retractable hose 89 connects nozzle 82 to the water tank 46 located on board fire fighting vehicle 32. Alternate sources of cold water such as pump 64, fire hydrant 58 and water supply vehicle 54 may be used to supply cold water to nozzle 82.

Referring to FIG. 5, there is shown an electrical circuit 90 for supplying power to a trio of fan motors 102, 104, and 106 which are used to rotate fan blades 42 generating air flow at flow rates in the thirty to two hundred miles/hour range to assist in fighting fires in extremely hot, windy and dry conditions. Electrical circuit 90, which is located on board vehicle 32, includes a generator 92 for supplying electrical power to fan motors 102, 104 and 106. Generator 92 may be either a direct current source or an alternating current source.

Connected to generator 92 is a normally open push button switch 94 which when closed energizes fans 102, 104 and 106. A green light 96 connected in series to push button switch 94 provides an indication that fans 102, 104 and 106 are operational when light 96 is illuminated. A fuze 98 connected to green light 96 provides overload protection against excess current flow to fans 102, 104 and 106 which could damage fan motors. Speed control for fans 92, 94 and 96 is provided by a variable resistor 100 which controls current flow to fans 102, 104 and 106. By increasing current flow to fans 102, 104 and 106 their speed in revolutions per minute is increased and a reduction in current flow to fans 102, 104 and 106 results in a reduction in their speed. Circuit 90 also includes a pump motor 107 and meters 108 which are connected to one another and fan 106 and generator 92. Pump motor 107 is powered by generator 92 and is used when water is pumped from an external source of water such as a lake, stream or reservoir. Meters 108 are used to measure the speed of fans 102, 104 and 106 by measuring current flow through circuit 90. This, in turn, provides an indication of wind speed generated by fans 102, 104 and 106.

The push button switch 94, variable resistor 100, green light 96 and meters 108 are located in the cab 38 of fire fighting vehicle 32, providing the user of fire fighting vehicle easy access to the controls and monitoring devices of weather adjustment system 10.

The present invention can include more than one nozzle to provide cold water to the cold water stream formed by fan/blower 34. In addition, the fan blade assembly and nozzles could be integrated into the fan housing to form a unitary structure to generate a stream of cold water particles to fight forest and brush fires under dry, winding and hot conditions. A screen mesh may also be integrated into the structure to the fan housing to insure very fine particles of cold water are directed at the fire.

The generator 92 may be replaced with a diesel powered generator for generating the electrical current required to activate fan motors 102, 104 and 106. The use of a diesel powered generator is preferred in remote areas where conventional sources of power are not readily available. Other sources of electrical power for fan motors 102, 104 and 106 include solar power cells, wind driven electrical generators, and tapping electrical transmission lines. The electrical power source selected to power the fan motors depends upon the power requirements, i.e. how many fan powers are being driven by the power source; weather conditions; ability to access conventional sources of electrical power such as transmission lines and the location of the fire, i.e. is the fire in a remote location where access to conventional is not possible.

From the foregoing, it may readily be seen that the present invention comprises a new unique and exceedingly useful weather adjustment system for fighting fires which constitutes a considerable improvement over the known prior art. Obviously many modifications and variations of the present invention are possible in light of the above teachings. It is therefore to be understood that within the scope of the appended claims that the invention may be practiced otherwise than specifically described.

What is claimed is:

1. A weather adjustment system for extinguishing forest and brush fires comprising:
blower means for generating a stream of air, said stream of air being generated by said blower means at velocities of between 30 mph and 200 mph;
power generating means for supplying electrical power to said blower means to energize said blower means
means for providing a cold liquid to lower temperatures at said forest and brush fires; and
injection means for injecting said cold liquid into said stream of air to form particles of said cold liquid within said stream of air, the particles of said cold liquid within said stream of air being directed at said forest and brush fires lowering the temperatures at said forest and brush fires extinguishing said forest and brush fires.

2. The weather adjustment system of claim 1 further comprising means for substantially reducing a size for the particles of said cold liquid within said stream of air to a range of 10 microns to 200 microns.

3. The weather adjustment system of claim 1 wherein said cold liquid comprises water with a temperature range of 40 degrees Fahrenheit to 70 degrees Fahrenheit.

4. The weather adjustment system of claim 1 wherein said power generating means comprises:
an electrical current generator for generating said electrical current;
a normally open push button switch connected to said electrical current generator and said blower means, said normally open push button switch when closed energizing said blower means;
a green light connected to said normally open push button switch and said blower means, said green light providing an indication that said normally open push button switch is closed and said blower means is operational when said green light is illuminated; and
a fuze connected to said green light and said blower means to provide current overload protection for said blower means.

5. The weather adjustment system of claim 1 wherein said blower comprises of a plurality of fans, each of said plurality of fans having housing, a fan blade assembly rotatably mounted in said housing and a fan motor connected to said fan blade assembly to rotate said fan blade assembly when said power generating means supplies said electrical power to said fan motor.

6. The weather adjustment system of claim 1 wherein said means for providing said cold liquid comprises a pump for withdrawing said cold liquid from a reservoir and then supplying said cold liquid to said injection means, said pump including a pump motor connected to said power generating means to receive said electrical power which activates said pump motor, said pump withdrawing said cold liquid from said reservoir and then supplying said cold liquid to said injection means when said pump motor is activated.

7. The weather adjustment system of claim 1 wherein said blower means and said injection means are mounted on a fire fighting vehicle to allow said fire fighting vehicle to transport said blower means and said injection means to said forest and brush fires.

8. The weather adjustment system of claim 7 wherein said blower means consist of a plurality of fans an injection means consist of a plurality of nozzles wherein one nozzle of said plurality of nozzle is positioned in proximity to each of said plurality of fans.

9. A weather adjustment system for extinguishing forest and brush fires comprising:
a blower for generating a stream of air, said blower having a housing, a fan blade assembly rotatably mounted within said housing and a fan motor connected to said fan blade assembly to rotate said fan blade assembly to generate said stream of air at velocities of between 30 mph and 200 mph;
a power generating circuit for supplying electrical power to said fan motor to energize said fan motor, said fan motor when energized rotating said fan blade assembly which generates said stream of air, said power generating circuit including:
an electrical current generator for generating said electrical current;
a normally open push button switch connected to said electrical current generator and said fan motor, said normally open push button switch when closed energizing said fan motor;
a green light connected to said normally open push button switch and said fan motor, said green light providing an indication that said normally open push button switch is closed and said fan motor is operational when said green light is illuminated; and
a fuze connected to said green light and said fan motor to provide current overload protection for said fan motor;
a source of liquid for providing cold water to lower temperatures at said forest and brush fires;
a nozzle positioned in proximity to said blower, said nozzle being connected to said source of liquid to receive said cold water from said source of liquid, said nozzle injecting said cold water into said stream of air to form particles of said cold water within said stream of air, the particles of said cold water within said stream of air being directed at said forest and brush fires lowering the temperatures at said forest and brush fires extinguishing said forest and brush fires.

10. The weather adjustment system of claim 9 further comprising a screen mesh positioned downstream from said nozzle and said blower to substantially reduce a size for the particles of said cold liquid within said stream of air to a range of 10 microns to 200 microns.

11. The weather adjustment system of claim 9 wherein the particles of said cold water are within a temperature range of 40 degrees Fahrenheit to 70 degrees Fahrenheit.

12. The weather adjustment system of claim 9 wherein said source of liquid comprises a pump for withdrawing said cold water from a reservoir, said pump being connected to said nozzle to supply said cold liquid to said nozzle, said pump including a pump motor connected to said electrical current generator to receive said electrical power which activates said pump motor, said pump withdrawing said cold water from a reservoir and supplying said cold water to said nozzle when said pump motor is activated.

13. The weather adjustment apparatus of claim 9 wherein said source of liquid comprises a fire fighting vehicle which includes a water tank and a hose which has one end connected to said nozzle and the other end connected to said water tank.

14. The weather adjustment apparatus of claim 9 wherein said blower and said nozzle are mounted on a fire fighting vehicle to allow said fire fighting vehicle to transport said blower and said nozzle to said forest and brush fires.

15. The weather adjustment apparatus of claim 14 wherein said blower and said nozzle are mounted on a first platform attached to a head end of a boom, a tail end of said boom being attached to a second platform rotatably mounted on a rear end of said fire fighting vehicle, said second platform rotating three hundred sixty degrees allowing a user of said fire fighting vehicle to rotate said boom, said nozzle and said blower, said boom including a ladder which extends outward from a lower portion of said boom and retracts into the lower portion of said boom, and a pair of hydraulic attached to said second platform and said boom, said hydraulic jacks raising and lowering said boom, said first platform, said blower and said nozzle, said second platform, said ladder and said pair of hydraulic jacks allowing a user of said weather adjustment apparatus to position said blower and said nozzle to effectively fight and extinguish said forest and brush fires.

16. The weather adjustment apparatus of claim 9 wherein said source of liquid comprises a fire hydrant located in proximity to said nozzle and a hose having one end connected to said fire hydrant and an opposite end connected to said nozzle.

17. A method for extinguishing forest and brush fires comprising the steps of:
(a) generating a stream of air wherein said stream of air is generated at velocities of between 30 mph and 200 mph;
(b) providing a cold liquid to lower temperatures at said forest and brush fires, said cold liquid having a temperature range of 40 degrees Fahrenheit to 70 degrees Fahrenheit;
©) injecting said cold liquid into said stream of air to form particles of said cold liquid within said stream of air;
(d) lowering the temperatures at said forest and brush fires by directing the particles of said cold liquid within said stream of air; and
(e) extinguishing said forest and brush fires wherein the particles of said cold liquid within said stream of air when directed at said forest and brush fires lower the temperatures at said forest and brush fires which extinguishes said forest and brush fires.

18. The method of claim 17 further comprising the step of reducing a size for the particles of said cold liquid within said stream of air to a range of 10 microns to 200 microns.

19. The method of claim 16 wherein a blower having a housing, a fan blade assembly rotatably mounted within said housing and a fan motor connected to said fan blade assembly to rotate said fan blade assembly generates said stream of air at said velocities of between 30 mph and 200 mph.

20. The method of claim 1 wherein a nozzle injects said cold liquid into said stream of air to form particles of said cold liquid within said stream of air and a pump connected to said nozzle withdraws said cold liquid from a reservoir and then supplies said cold liquid to said reservoir.
